(19) United States
(12) Patent Application Publication
(10) Pub. No.: US 2012/0179401 A1
(43) Pub. Date: Jul. 12, 2012

(54) INTRUSION DETECTION SYSTEM WITH LOCATION CAPABILITY

(75) Inventor: Yehonatan Ben-Hamozeg, Rosh Ha'ain (IL)

(73) Assignee: MAGAL SECURITY SYSTEMS LTD., Yahud (IL)

(21) Appl. No.: 13/497,227

(22) PCT Filed: Sep. 20, 2010
(86) PCT No.: PCT/IL10/00773

§ 371 Date: Mar. 20, 2012

(30) Foreign Application Priority Data
Sep. 21, 2009 (IL) 201078

(51) Int. Cl. G06F 19/00

(52) U.S. Cl. 702/64

(57) ABSTRACT

An intrusion detection and warning system and method capable of pinpointing location of a breaking in attempt wherein the system relies on vibration sensors positioned along a sensor line that is installable on a fence sector, a signal processing unit located on one end of the sensors line and said sector resistor is placed at a second, other end of the sensor line and connected to it. Wherein the system is characterized by an array of parallel formation resistors that are each connected to a vibration sensor. Wherein one end of each of the resistor is connected to the sensors line, the other end is connected to a voltage measurements line. The system defines at said voltage measurements line, a point in which a voltage can be sampled, and wherein in addition, the system includes a sampler that enables sampling the voltage at said define point.

### FIELD OF THE INVENTION

The present invention, the subject matter of this application, relates to the field of Intrusion Detection Systems in general, for example systems that are based on a sector of a circumferential fence that is installed with sensors on it that are designated to detect intrusion attempts through the fence or by climbing over it, and especially—in the field of such systems, dealing with those that have the capability to locate (pinpoint) the intrusion location and thus provide real time information (exact data) concerning the exact location wherein the intrusion (or intrusions) is (are) happening along a given sector of the fence.

### BACKGROUND OF THE INVENTION

Intrusion Detection Systems are familiar and well known, for example such systems that are based on implementing vibration sensors that are located alongside the entire fence circumference, at a given distance one from the other (e.g., 2 to 3 meters).

A typical example of such systems is the system known commercially by its name “Barricade”. See the description of the “Barricade” system given in the internet site of the applicant of the present invention, using the link:

http://www.magal-ssl.com/Admin/FileServer/d8c7824c688644fd3681f58d09e4bc22.pdf

Various generations of the sensors of the “Barricade” systems and of components associated with it are described in many places, for example—in patents: U.S. Pat. No. 4,107,545, U.S. Pat. No. 6,737,972, and U.S. Pat. No. 7,532,188.

It is important to notice that though the invention, the subject matter of this application, would be described in what follows—solely by referring to (and/or by comparison to) the above mentioned “Barricade” system, any professional would understand that the subject matter of this discussion constitutes solely an example that was given for reasons of convenience (as a fitting example) and that the invention, as said (the subject matter of this application,) can be implemented also in other intrusion detection systems that are different and other than the cited one, but they are still based on incorporating vibration sensors, such that from the instant that they are exposed to common phenomena accompanying intrusion (shocks, vibrations, movements) vibrate in a swift transition (i.e, passage) from states of short circuits to states of cut-offs (as known and occurring in electrical circuits). In other words, the subject of discussion are sensors that in case they are subjected (or—in other words, they are exposed) to the phenomena as said that accompany the intrusion activities, such as shocks, vibrations of the fence unto which they are connected etc., the vibration sensor “toggles” from the electrical short circuit state in which it is regularly found at rest, to the cut off state and vice versa.

Let's refer to FIG. No. 1. FIG. No. 1 constitutes an illustrated example of a sector (section) 10 of the “Barricade” system, that comprises a fence 15 (in the illustrated example—a welded net type of fence), wherein a sensors line 20 is deployed on it. Said sensors line is made of sensors 25 (designated 25ₙ₁ to 25ₙ₅₀), that are positioned in series and distanced one from the other, and through them—continuously and all the time—there passes an electric current of a fixed (constant) value supplied by an electricity power source 27 (that might be a current source or a voltage source with a resistor in series for supplying the constant current to the sensors line—for example 0.5 milliamps).

At the end of the sensors line 20 and in series with it, an “end of line” resistor 30 is connected (for producing resistance at the stable- (steady-) state of the system—that is to say—when there is no indication of sensing an intrusion along the entire length of the sector, because all the sensors are found in their regular state—the shorted circuit state).

Signal processing unit 35 is connected with the sensors line 20 (its beginning and its end) for receiving signals in case a warning is raised by one of the sensors or by several of them. The unit processes the data signal received from the sensor and produces an intrusion warning. The electricity power source 27 that is connected to the sensors line 20 is installed in the signal processing unit 35.

Reference is being made to FIG. No. 2. FIG. No. 2 constitutes an electrical scheme of sector 10 wherein it illustrates an occurrence of a disconnected state of sensor 25ₙ₄₈, in a manner such that signal processing unit 35 detects a change and discerns it in the flowing current, that as said, is being passed all the time in the sensors line 20 from the cited electricity power source 27 (the vibrating sensor's current “toggles” and dropped to zero because of the disconnection that occurred due to the intrusion incident at the relevant sector of the fence at the specific site of the fence wherein it is connected).

Any professional would understand that in a system as the one that was described above, the resolution of determining the location and pinpointing the site (“point”) of the break in occurrence, is low. This is so, because the signal processing unit 35 is capable of identifying solely an intrusion occurrence in one only and unknown location within sector 30. In other words, the system that was described above does not have the capability to pinpoint (provide exact location) of the intrusion point within the given sector (a given sector that might be relatively long).

Wherein (as is the case) that a given sector of an actual “Barricade” system—might be 150 meters long, it is evident that a general alarm regarding an intrusion occurrence somewhere within those 150 meters would still present (even cause) difficulties, delaying and endangering the emergency squad that has to locate the intrusion based on such general non accurate information (e.g.—an intrusion somewhere along the 150 meters long sector).

An additional problem is embodied in the difficulty to swiftly pinpoint the exact position of a faulty (out of order) sensor device within the given sector.

A different and additional problem is the multitude of false alarms inherent in the system, because the alarm threshold is allocated to all the sector, and not to a specific sensor device lodged in it, and therefore the probability of false alarms in a relatively long sector with a multitude of sensors (every few meters) is statistically higher than the statistical probability of false alarms occurring in a given sensor that can be pinpointed individually.

An additional and once more different problem is the absence of capability of coping simultaneously with several intruders within the same sector. Verily, the current type of systems would be able to raise an alarm (generate a warning) about the occurrence of a break in (intrusion attempt—somewhere along the length of the sector, that might be as much as 150 meters long), but—the current system would not be able to provide nor to indicate the number of the intruding occurrences, nor even at least—to inform that the problem is that there are several points of break in concurrently along the sector. Thus—

At the period that preceded the development of the present invention, an improvement of the configuration of the “Barricade” system (or similar ones) was essential and required to provide such a method that it would instill in them the capability of identifying vibrations in each and every specific sensor that is located at that sector of the fence. In this manner, the warning sector would be reduced from a multi (common) sensors sector (as for example, sector 10 in FIG. No. 1, whose characteristic length is approximately 150 meter), to pinpointing exactly the specific sensor in it—i.e., two to three (2-3) meter.

Concurrently, there are well known and familiar publications regarding intrusion detection systems that enable to pinpoint the exact location of the intrusion, that implement—inter alia, also resistors type of elements as being a part of various electrical systems. For example, consider the following patents: DE 396842, IT 1265197, FR 2638877, GB 2036398, U.S. Pat. No. 4,651,138, U.S. Pat. No. 4,441,100.

### SUMMARY OF THE PRESENT INVENTION

The present invention, the subject matter of this application, copes with the existing deficiencies that we pointed at in the “Background of the Invention” chapter. This is achieved by producing a unique (“personal”) electric pulse for every sensor in the system. Thus, actually, regarding all that is linked to pinpointing the locality of the intrusion, a characteristic sector of the fence is no longer a “multi sensors sector” and relatively long, but rather it is reduced to the single sensor level (while achieving pinpointing accuracy of two to three (2-3) meters along the fence line wherein there is installed a system such as the “Barricade” system or systems that are similar to it.

In a preferred embodiment of the invention—the subject being considered is a warning system for detecting intrusion occurrences endowed with the capability to pinpoint the exact position of the incidence, wherein—like the “Barricade” and similar aforementioned intrusion detecting systems—it too comprises and relies on vibration sensors of the type that when sensing an incident produce a continuum of alternating electrical short circuits and cut off instances (sequences), occurring along the sensors line that is installable on a fence; a signal processing unit that is located on a one end of the sensors line and connected to it; power supply source that is also connected to the sensors line; and an end of the sector resistor that is placed at the second (other) end of the sensors' line and is connected to it.

A prominent characteristic of the system in accordance with the invention (the subject matter of this application) is expressed by the fact that the system includes—in addition, an array (or a line) of resistors in a parallel formation, that are connected, each one of the resistors, to a vibrating sensor that is assigned to it. In a preferred configuration of the present invention, each resistor is connected on the distanced side of the sensor (from the signal processing unit), and wherein a one end of each of the resistors is connected to the sensors line, while its other end is connected to a voltage measurements line, and in addition the voltage measurements line is connected to a voltage measurements resistor and to the signal processing unit.

An additional and different characteristic of the system in accordance with the present invention, the subject matter of this patent application is expressed the fact that the structure of the systems enables to define at least one point wherein sampling of the voltage is possible.

In one configuration of the system, the invention provide for a voltage that is measured across the voltage measurements line (see a point denoted V2 in FIG. No. 3) and wherein the system includes also a sampling device that enables sampling the voltage at said point. In another preferred configuration of the system, an additional measurable point is define, wherein we refer to the physical contact (connection) point of the resistor that was allocated to the most distanced sensor (from the signal processing unit), (see the point denoted V3 in FIG. No. 3), and wherein the sampling device enables to sample the voltage also in this additional point (in addition to sampling in point V2).

In an additional and different aspect of the invention, the subject matter of this patent application—we divulge a generic method that is applicable to systems for detecting intrusion occurrences cited in the summary of the invention chapter, intended to pinpoint the exact site (position) wherein there is an occurrence of an intrusion act taking place along the sensors line, that triggered a certain sensor in the system to a state of temporary cut-off disconnection. In one configuration of the system, we present a method that includes the steps of sampling the voltage in the voltages voltage measurements line (V2); comparing the measured voltage to a pre-prepared calibration table; and attributing the measured voltage level to a specific sensor whose location is known somewhere along the sensors line.

In an additional and different version of the method, it includes the stages of sampling the voltage in the voltages measurements line (V2); and at a point of the connection of the resistor that is attributed (allocated) to the farthest away from the signal processing unit sensor, with the voltages measurements line (V3); and calculating the distance (“in sensors” terms), (see in FIG. No. 3 the distance that was designated as N2), between the specific sensor that vibrated up to repeating and re-occurring states of cut off (a disconnection) to the last sensor in the sector, by applying an equation that links the results of sampling the voltage at the above cited points (namely V2 and V3) with the resisting values of a typical resistor in the resistors array and the “end of sector” resistor.

### BRIEF DESCRIPTION OF THE ACCOMPANYING FIGURES

The present invention will be described hereinafter in conjunction with the accompanying figures. Identical components, wherein some of them are presented in the same figure—or in case that a same component appears in several figures, will carry an identical number.

FIG. No. 1 constitutes an illustration of a sector of the “Barricade” system (prior art).

FIG. No. 2 constitutes an electrical circuit schema of said “Barricade” system (prior art), wherein one of the sensors is in a disconnected (open circuit) state.

FIG. No. 3 constitutes an electrical circuit schema of an intrusion detection system in accordance with the present invention, that has a capability to pinpoint (namely, locating) the position of an intrusion occurrence.

FIG. No. 4 constitutes an illustration expressing pulses as they are observed at the input (entrance) of the signal processing unit in a “Barricade” system (prior art) from the instant that the break in attempt is in progress.

FIG. No. 5 constitutes an illustration expressing the pulses as they are observed at a specific sampling point in a system in accordance with the present invention, when break in (intrusion) attempt is occurring in several places simultaneously.

FIG. No. 6 constitutes an illustration of a displayed expression of the electrical pulses as they are viewed at a given, specific sampling point in a system in accordance with the present invention, when an occurrence of intrusion attempts occur at several sites (points) in a given sector.

FIG. No. 7 constitutes an illustration of a displayed histogram of the viewed pulses that were illustrated in FIG. No. 6.

### DETAILED DESCRIPTION OF A PREFERRED EMBODIMENT OF THE INVENTION

Let's refer to FIG. No. 3. FIG. No. 3 constitutes an electrical scheme of the intrusion warning system 310 for detecting penetrations combined with capability of localizing (i.e. pin-pointing the intrusion location in accordance with the present invention.

Intrusion warning system 310 might be based on, for example, the “Barricade” system that we cited above (in the “Background of the Invention” chapter), that comprises—a signal processing unit 335, an array of sensors (dubbed also a sensors line) 320 along whose length there are installed vibration sensors (that were designated 325ₙ₁ and 325ₙ₅₀), a power supply source 327 (which is a current source or a voltage source with a resistor connected in series for supplying constant current to the sensors line), that might be installed as illustrated—namely as an integral part of signal processing unit 335 and connected to sensors line 320, and a section's end resistor 330. The schematic illustration is shown as it is in an occurrence of cut off in sensor 325ₙ₄₈.

A characteristic of the present invention is expressed, inter alia, by having a resistor component connected to each one of the sensors.

Considering FIG. No. 3, the subject of discussion is its paralleled array of resistors 360ₙ₁ to 360ₙ₅₀. Every one of the resistors is connected on its one end to sensors line 320 (in the illustrated preferred configuration—it is on the right to of the specific resistor unto which it is connected, namely—on its far side that is distanced from signal processing unit 335—but might also be connected, alternatively, on the sensor second side). The second end of each resistor (360ₙ₁ to 360ₙ₅₀) is connected to a voltages measurement line 370.

The voltages measurement line 370 is connected, to 380Rb—a resistor's voltage measurement item, and to the above cited signal processing unit 335.

The electric system scheme of this system in accordance with the present invention includes in addition (see FIG. No. 3) two voltage sampling points—390_{V2} and 390_{V3}, that, as would be clarified later, serve the signal processing unit 335.

In the illustrated state (disconnected state in sensor 325ₙ₄₈) current would flow up to the position of the disconnection (cut off) and through the weighed resistor situated after it (as a consequence of the positioning of the resistors alongside each of the sensors).

Any professional proficient in the electricity field would understand that a different location of the disconnection (cut off) along the sensors line would produce a different weighed resistance. In other words—

at points 390_{V2} and 390_{V3} there will be measured a couple of two voltages, one different than the other, and the two voltages that would be measured will by themselves also be different one from the other, according to the site (or position) of the occurrence of the disconnection (by a cut off) along the sensors line.

Hence, when there is given an implementation of a suitable algorithm in the micro-processor equipped signal processing unit 335, it is feasible to accurately pinpoint the location of a specific vibrating sensor (325ₙ₄₈ in the illustrated example) that toggles to the momentary disconnected state in the sensors line (probably due to an intrusion attempt in its immediate vicinity).

An additional challenge, which the intrusion detecting system has to cope with, is the scenario that according to it—simultaneously—along the sensors line of a given sector, a number of sensors are subjected to or in other words—are exposed to, these phenomena accompany an intrusion attempt while causing several sensors to toggle from their normal state to the momentary disconnected one.

Any professional would understand that in this situation, the signal processing unit has to track several different alarms from the different sensors (multiple threats).

Any professional would understand that a vibration sensor of the type installed in the cited “Barricade” system (and as quoted in the prior art; and see also above in the “Background of the Invention” chapter), produces a series of electrical pulses (much like a “train” of electrical pulses), having different lengths one from the other (easily discerned within a long duration), from the instant that the sensor is subjected to or—in other words—exposed to these phenomena that occurs when there is an intrusion attempt to break in through a fence sector in the vicinity of the sensor, or attempt is being made to climb over the fence (for example generating shocks, vibrations etc.).

Attention is called to FIG. No. 4. FIG. No. 4 constitutes an illustration expressing the pulses produced by one or more of the sensors along the sensors line, from the instant that the break in attempt started, as they were observed at the input (entrance) of the signal processing unit in a system of the “Barricade” type (prior art).

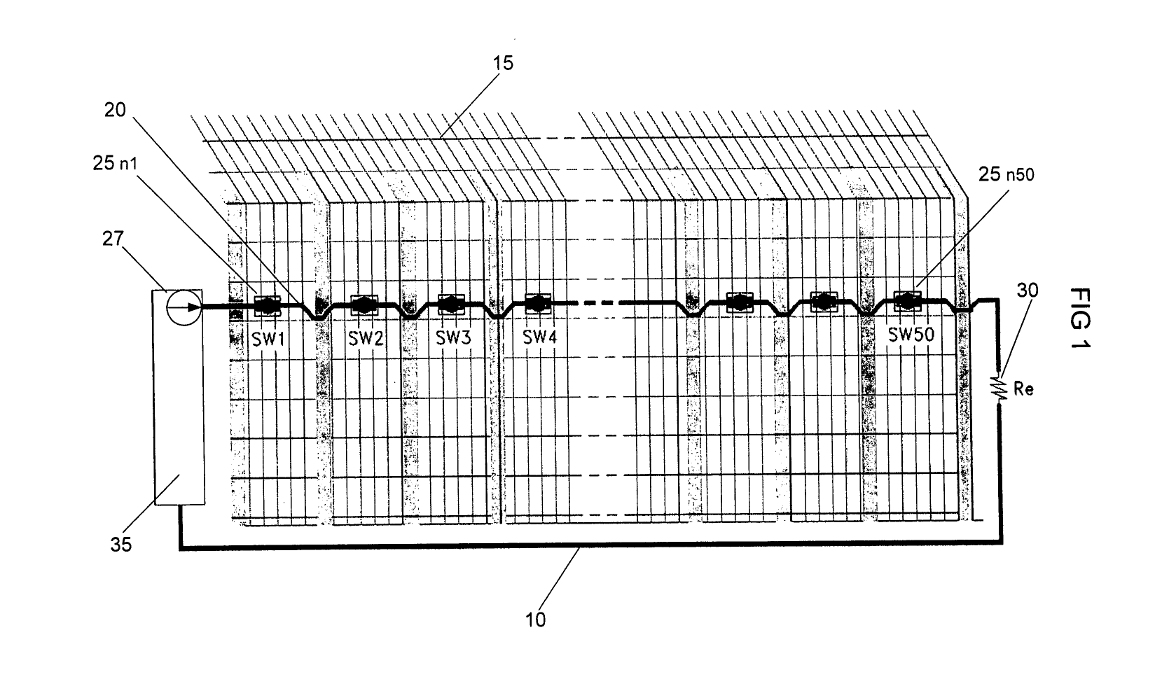

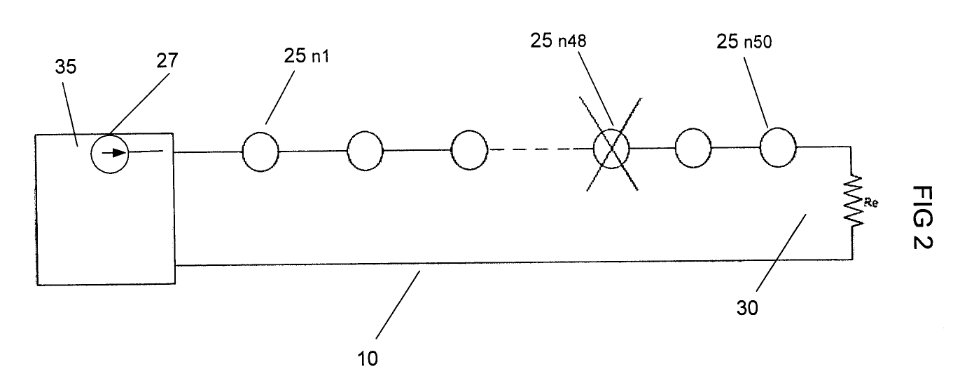

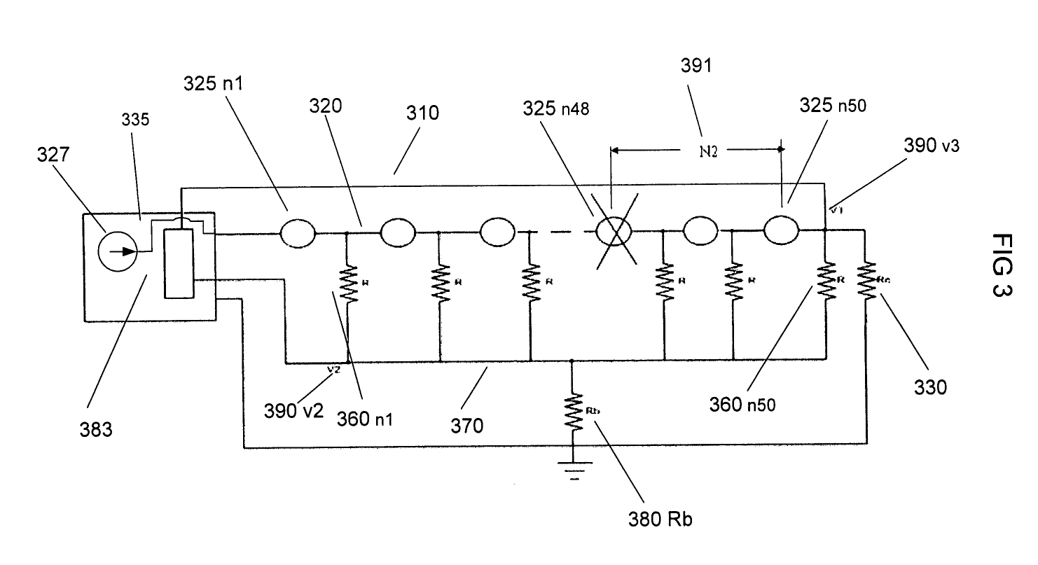

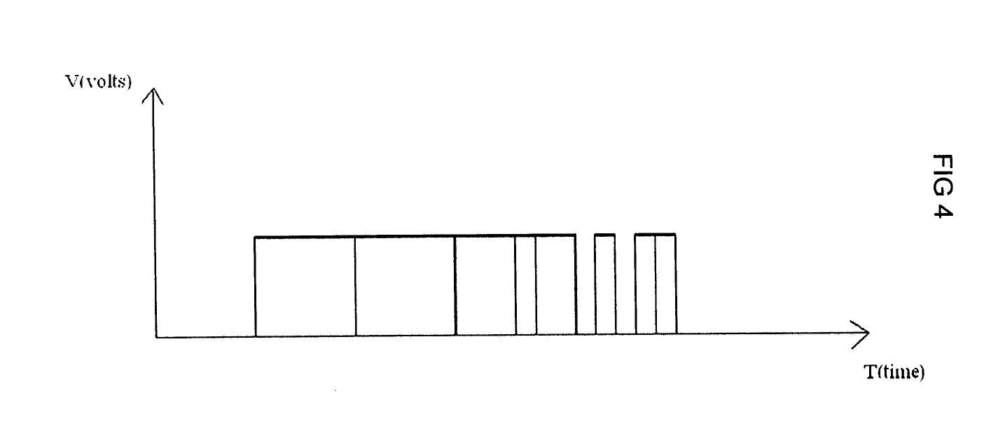

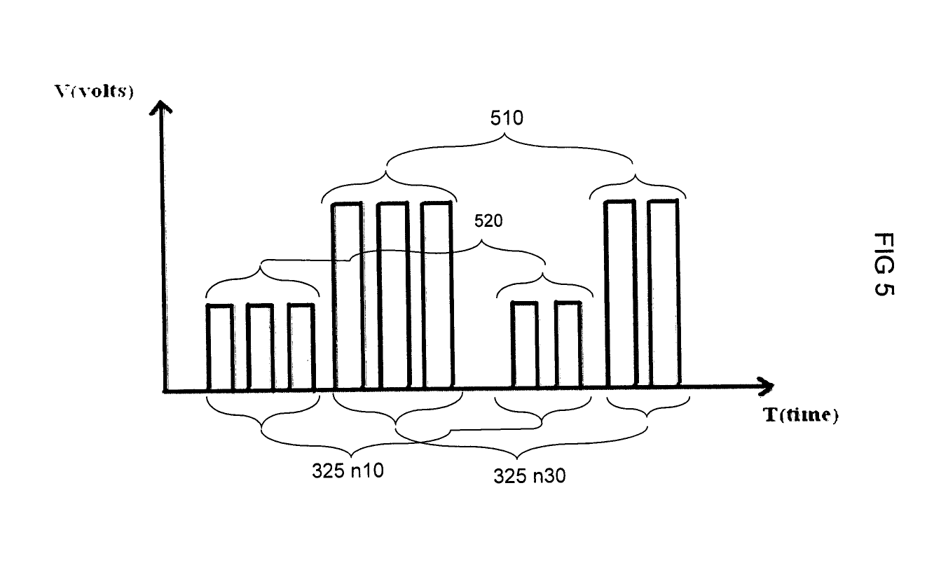

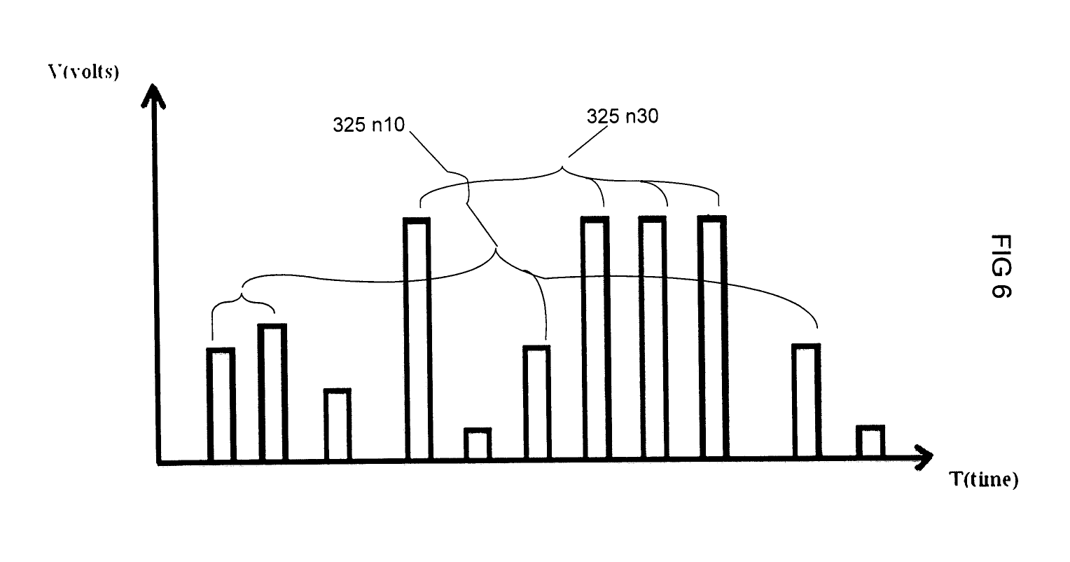

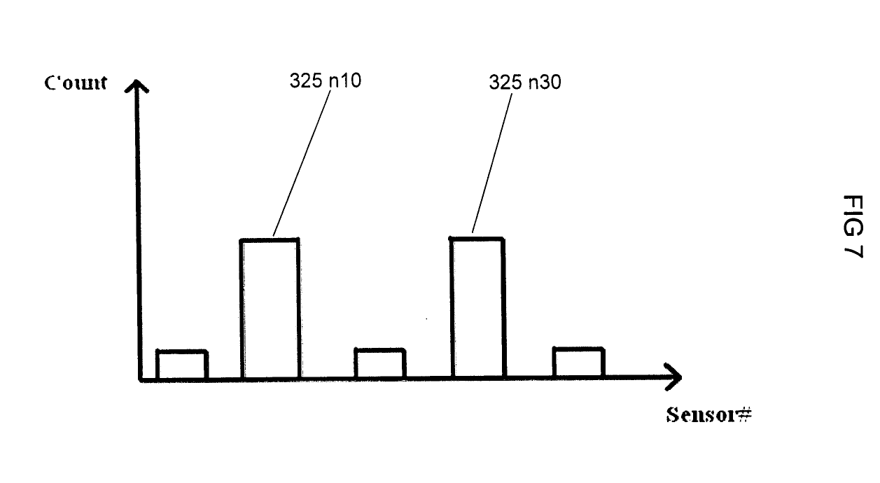

Let's refer to FIG. No. 5. FIG. No. 5 constitutes an illustration expressing the pulses by displaying how they are observed at a specific sampling point 390_{V2} (see FIG. 3) in accordance with the present invention, when a break (intrusion) attempt is occurring simultaneously in several places (points) along the fence.

In a different approach than that that is applicable to FIG. No. 4, in a system that is in accordance with the invention and at the specific sampling point 390_{V2} that exists in the system and is marked in FIG. 3 (and does not exist in systems that are in accordance with prior art that was described above when referring to FIG. No. 4)—the voltage value varies as a function of the relevant sensor (namely—the sensor in which the detected vibration occurred and led to toggling it from the short circuited state to the momentary open circuit state). The pulses of a relative higher voltage value are produced by sensors that are farther away from the head of the sensors line (remote from the signal processing unit 35).

Thus, for example in FIG. No. 5, pulses 510 (see figure) are attributed to sensor 325ₙ₃₀ (a sensor that is relatively distanced from the signal processing unit—and see in FIG. No. 3—a continuum of sensors that were denoted 325ₙ₁ to 325ₙ₅₀ spread to the right as its distance is farther away from the signal processing unit), and pulses 520 that are essentially with voltage value lower height than pulses 510, and in the illustrated example are attributed to sensor 325ₙ₁₀ which is a sensor located relatively near to the signal processing unit (see FIG. 3, once more).

Any professional would understand that the indications by pulses that are essentially different one from the other in their voltage value, might serve as expressions of the occurrence of vibrations in sensors that are positioned at a number of various locations along the sector being considered (length wise) along the anti intrusion system, and, in accordance with the invention in such a manner that it would point at (and warn of) the occurrence of a break-in—at several sites along the sensors line (namely—the perimeter fence), or on the exposure of several sensors to a general phenomena that occurs simultaneously along the line, e.g., blowing wind.

An algorithm that might be suitable for the signal processing unit such that with this algorithm it becomes feasible to accurately pinpoint the position of the vibration occurrence, that led a specific sensor to the momentarily current cut off state along the sensors line, might be based on information that was sampled at the 390_{V2} sampling point.

For example, when the signal processing unit samples a voltage sample that is between zero (0) and 3.3 volt, the resistors values (see FIG. No. 3) would be selected in a manner that would enable variation of the measured voltage at sampling point 390_{V2} within this quoted voltage limits. The signal processing unit would turn to a ready, pre calculated calibration table (with expected threshold values for each sensor individually) and would attribute (allocate) the measured voltage level to the suitable specific sensor along the line.

An additional viable algorithm, alternative or integrated with another algorithm, that would enable to accurately pinpoint, as said, the exact site (or point) of the occurrence of an intrusion (that triggered a sensor in its immediate vicinity to the typical vibrations and toggling between momentary cut-offs and short circuited states), might be based on the above cited two sampling points 390_{V2} and 390_{V3} (mentioned when referring to FIG. No. 3).

The method includes a calculation (in a marked contra distinction with the previously cited method of comparison with a pre-prepared calibration table) whose result is the distance—pronounced by the number of sensors between the specific sensor that was vibrated and the last sensor in that sector. In other words—the produced distance value is between the specific sensor brought to vibrations and toggling between repeated momentary cut-off states and short circuited states to the last sensor in the sector. This distance is denoted N2 (and see the entity designated 391 in FIG. No. 3).

Any professional would understand that the electrical schema illustrated in FIG. No. 3 fulfills the following equation—

$${V}_{3} = \frac{R / {N}_{2}}{R / {N}_{2} + {R}_{e}} {V}_{2} \qquad Eqn . No . 1$$

Where—
R—a resistor connected—in accordance with the invention, to each resistor (marked 360 in FIG. No. 3)
Re—an “end of sector” resistor (marked 330 in FIG. No. 3)
V2—the value of the sampled voltage at point V2 (marked 390_{V2} in FIG. No. 3)
V3—the value of the sampled voltage at point V3 (marked 390_{V3} in FIG. No. 3)

From the above equation (No. 1), it is possible to extract the required value N2, as follows—

$${N}_{2} = \frac{R / {R}_{e}}{{V}_{2} - {V}_{3}} {V}_{3} \qquad Eqn . No . 2$$

wherein as said, N2 is a distance pronounced by the number of sensors between the specific sensor that was vibrated and the last sensor in that sector (marked 391 in the illustrated example of FIG. No. 3).

The advantage offered by this method is that there is no need to prepare in advance a calibration table or chart, as this method is based on a calculation (a value—not a comparison). One additional advantage is that this method is a rather flexible method and enables to implement it for varying numbers of sensors as they exist in a specific system.

Any professional would understand that in a system in accordance with the invention there is embodied an additional advantage as compared to systems known from prior art and cited above (such as the “Barricade” type of system that we cited more than once (see, e.g., the “Background of the invention” chapter).

In contra distinction, a system in accordance with the invention—the subject matter of this application, enables the signal processing unit to cope with a plurality of indications provided simultaneously from several sensors (two or more), and materialized as an outcome of touching the—or breaking in through—the fence. This, subject to the assumption that from the statistical point of view, the phenomena accompanying intrusion (shocks, vibrations, movements), although vibrate in a swift transition (or passage) from states of short circuits to states of cut-off and vice versa, a plurality of sensors, in each one of the triggered sensors, such transitions occur with a lag in the time axis in one sensor relative to the other. It is also to be noted that the vibration response that occurs—in one sensor or more, which is the sensor that is relatively nearer to the signal processing unit, occurs at a rather low frequency so that it enables measurements of a sensor's voltage of a second sensor relatively farther away that is also vibrating (a measurement that would be enabled within the time span in which the nearer sensor stays in its short circuited state).

As we have pointed above, a system in accordance with the invention is able to discern any specific sensor within the sector, and subject to the above made and expressed assumption—then the system is able to handle and to cope with signals that are received simultaneously as said, due to several acts of touching or of actually intruding through the fence sector.

Reference is being made to FIGS. No. 6 and No. 7. FIG. No. 6 constitutes an illustration of the electrical pulses as they are viewed at a given, specific sampling point in the system in accordance with the present invention—and while the system is undergoing an occurrence of several intrusion attempts concurrently at several points in a given sector. FIG. No. 7 constitutes an illustration of a Histogram of the pulses that were illustrated in FIG. No. 6.

The phases of the pulses of the specific sensors that were exposed to the occurrence of the intrusion attempt/s (one or more at the same time along the sector) and thus “toggle” from the electrical short circuit state in which it is regularly found, to the cut off state and vice versa, are characteristic phases and different each one from any other in a manner that is easily given to discrimination (perception) by the naked eye (designated 325ₙ₁₀ and 325ₙ₃₀), and thus enable to produce a Histogram that would be endowed by explicit significance when referring to those specific sensors (see FIG. No. 7).

Any professional would appreciate the fact that an intrusion detection and warning system having the capability of pinpointing the accurate location of the threatening attempt as was described above, might be based in its implementation as per the majority of its hardware, on components that are already available in the field (as for example the components of the earlier cited “Barricade” system), with the addition of other common “off the shelf” obtainable devices and components. This set of components includes, for example, the array of identical resistors 360ₙ₁ to 360₅₀ (see FIG. No. 3) as well as the voltage measurement resistor 380Rb, a common sampling unit 383 for sampling various levels at the sampling points 390_{V2} and 390_{V3}, that as per this one—it might be integrally located within said signal processing unit 335, and of course the measurement wires; the voltage measurement line 370 (wherein one of them, the one intended for performing the measurement at the sampling point 390_{V3}, requires that it would be run along the length of the sensors line and preferably that it would be mounted as an integral part of this line).

Thus—an intrusion detection and warning system having the capability of pinpointing the threatening attempt accurate location in accordance with the invention as was described above, constitutes a major improvement as compared to other (existing) warning systems that are based on incorporating vibration sensors such as, for example—the “Barricade” system as well as similar systems, in that that it instills a capability to identify vibrations of each and every specific individual sensor that is installed in a given sector of a fence. By this manner, the warning sector is reduced from a multi sensors sector (such as sector 10 in FIG. No. 1, whose typical length is approximately 150 meters), to a sector having pinpointing resolution at the level of the specific resistor (the vibrating one), namely defining a two to three (2 to 3) meter long sub-sector. Verily, a system in accordance with the invention even does this by using standard, relatively low priced components.

Any professional would understand that the system as per the present invention and the methods that were described above while referring to the accompanying figures, were given only in a way of presenting examples of the invention, serving our descriptive needs. Changes or variants in the structure of the system or selection of its components would not exclude them from the framework of the invention.

In other words, it is feasible to implement the invention as it was described above while referring to the accompanying figures, also with introducing changes and additions that would not depart from the constructional characteristics of the invention, characteristics that are claimed herein under.

1. An intrusion detection and warning system having a capability of pinpointing location of a breaking in attempt that comprises—
vibration sensors position along a sensors line that is installable on a fence sector and wherein said sensors are of a type that upon intrusion, produces a continuum of alternating electrical states of short circuits and cut off instances; and
a signal processing unit that is located on one end of said sensors line and is connected to it; and
an electricity power supply source that is also connected to said sensors line; and
an end of said sector resistor that is placed at a second, other end of said sensor line and connected to it; and—
wherein said system is characterized by that that it includes in addition—
an array in a parallel formation of resistors that are connected, each of said resistors, to a vibration sensor that is attributed (or allocated) to it, and wherein one end of each of said resistors is connected to said sensors line, while its other end is connected to a voltage measurements line; and
in addition, said voltage measurements line is connected to a voltage measurements resistor and to said signal processing unit; and
wherein said system defines at said voltage measurements line, a point in which a voltage can be sampled (V2); and
wherein in addition, said system includes a sampler that enables sampling said voltage at said point.

2. An intrusion detection and warning system having a capability of pinpointing locations of breaking in attempts in accordance with claim No. 1, wherein—
said system defines one additional point that can be used for sampling said voltage, and wherein said second point being at a connection point of a resistor that was attributed to said most farther away (namely most distanced) sensor from said signal processing unit, with said voltage measurements line (V3); and
wherein said sampler enables also sampling voltages at said additional second point.

3. An intrusion detection and warning system having a capability of pinpointing location of breaking in attempts in accordance with claim No. 1, wherein—
each one of said resistors is connected to its attributed sensor, on said sensor's distanced side from said signal processing unit.

4. A method implementable in an intrusion detection and warning system in accordance with claim No. 1 for pinpointing a position of occurrence of a vibration along said line of sensors, that led a specific sensor in said system to a state of momentarily disconnection (cut of), that includes steps of—
voltage sampling in said voltage measurements line (V2); and
comparing said measured voltage with a pre-prepared calibration table; and
attributing said measured voltage level to a specific sensor as said, along said sensors line.

5. A method implementable in an intrusion detection and warning system in accordance with claim No. 2 for pinpointing a position of occurrence of a vibration along said line of sensors, that led a specific sensor in said system to a state of momentarily disconnection (cut of) state, that includes steps of—
sampling voltages at said point on said voltages measurements line (V2), and at said point of connection of said resistor that was attributed to said most distanced sensor from said signal processing unit with said voltage measurements line (V3); and
calculating a distance (in sensors). N2, between a specific sensor that was vibrated to state of toggling between repeated cut off's state, to said last sensor in said sector, by applying equation No. 1 that links said results of sampling voltages at said points (V2 and V3, respectively) with values of resistors measured by a characteristic resistor of said array of resistors and said end of sector resistor.
